(19) United States
(12) Patent Application Publication
(10) Pub. No.: US 2009/0003550 A1
(43) Pub. Date: Jan. 1, 2009

(54) METHOD AND SYSTEM FOR CALLING PARTY CONTROL OF RINGBACK TONE CONTENT

(76) Inventors: Babu Mani, Murphy, TX (US); Aqeel Siddiqui, Plano, TX (US)

Correspondence Address: ERICSSON INC., 6300 LEGACY DRIVE, M/S EVR 1-C-11, PLANO, TX, 75024, US

(21) Appl. No.: 11/768,501

(22) Filed: Jun. 26, 2007

(51) Int. Cl. H04M 1/64

(52) U.S. Cl. 379/88.19

(57) ABSTRACT

A method and system for allowing a subscriber of equipment to control the content of a Ring Back Tone (RBT) (i) based on a restriction level or maturity rating, or (ii) dynamically, during the process of connecting a call. More specifically, during call setup, (a) provisioned or subscribed RBT control can be based on maturity level and (b) dynamic RBT control, includes the ability to: override subscribed/provisioned restriction level, block RBT content being played permanently or skip RBT content being played during current call set up time.

### CROSS-REFERENCE TO RELATED APPLICATIONS

NOT APPLICABLE

### STATEMENT REGARDING FEDERALLY SPONSORED RESEARCH OR DEVELOPMENT

NOT APPLICABLE

### REFERENCE TO SEQUENCE LISTING, A TABLE, OR A COMPUTER PROGRAM LISTING COMPACT DISC APPENDIX

### NOT APPLICABLE

### BACKGROUND OF THE INVENTION

The present invention relates to telecommunication systems. More particularly, and not by way of limitation, the present invention is directed to a system and method for calling party control of the ringback tone (RBT) content. As used herein, the following abbreviations shall have the following meanings:

CAMEL—Customized Applications for Mobile Network Enhanced Logic

CPC—Calling Party's Category

CRBT—Color Ringback Tone

GMSC—Gateway MSC

HLR—Home Location Register

HSS—Home Subscriber Server

ISUP—ISDN User Part

LIDB—Line Information Database

MSC—Mobile Switching Center

RBT—Ringback Tone

SCP—Service Control Point

SIP—Session Initiation Protocol

In a call made over a telecommunications system using a wireless infrastructure, wireline infrastructure or both, a calling party uses telecommunication instrumentalities to signal a called party. The party that initiates the call is referred to as the caller, calling party, or originating party, and the party receiving the call is referred to as the called party, or terminating party. It is noted that a subscriber to a service may not be the actual calling party or called party. For example, a parent may be a subscriber to a wireless service, but the calling party or called party may be a child of the parent. As used herein, whether the subscriber and the calling/called party are the same or different persons depends on the context of the use of the term “subscriber”. Further, RBT is a terminating service that is invoked during call set up, hence the RBT subscriber is always the called party.

Telecommunication service providers have developed RBT, which is a service provided to subscribers, in their role as a called party, that enables them to substitute the regular audible ringing provided to a calling party with a tone or audio clip selected by the called party during the process of connecting a call. It is also possible to substitute the tone or the audio clip with other media content. Thus the RBT content presented to callers can be video, text, graphics, photos, etc., only limited by the capabilities of the caller's handset and the transmission capabilities of the telecommunications network. This service is also known as Color Ringback Tones (CRBT). Currently, the calling party is subjected to the RBT content selected by the called party.

There are mandated or voluntary ratings assigned to television, radio, motion pictures, video games and other entertainment. RBT service providers also rate RBT content. Many RBT service providers have established policies that restrict subscribers, in their role as called party and who are categorized as “parental controlled”, from purchasing inappropriate RBT content. The RBT content rating and the restrictions on the purchase or preview by parental controlled subscribers, such as minors, is in line with these ratings and control.

As noted above, the ability to restrict RBT content is made available to the called party, not the calling party. This is because RBT is a terminating subscriber service. In other words, a terminating user is the called party who subscribes to the RBT service and callers listen to RBT content as specified by the subscriber who is the called party. In this situation, the calling party is captive and has no way of opting out of or skipping the RBT. That is, the caller does not have control to override any preferences set by the called party.

It would be advantageous to have a system and method for allowing a subscriber, in their role as caller, to exercise control over the RBT content that is provided to the caller. Such control includes (a) provisioned or subscribed RBT control based on maturity level and (b) dynamic RBT control including ability to override subscribed/provisioned restriction level, block permanently content being played, and skipping content being played during current call set-up time. The present invention provides such a system and method.

### BRIEF SUMMARY OF THE INVENTION

The present invention is adapted to provide a subscriber, who is a caller, with the ability to activate, deactivate and/or otherwise control RBT content as heard on a caller's mobile handset, personal digital assistant, smart-phone, station, terminal, telephone or user equipment (sometimes referred to collectively herein as equipment or telephone). Caller control of RBT includes, but is not limited to the ability to override a called party's RBT selections, based on predefined Caller's maturity level, and/or Caller's instructions during call setup. More specifically, the present invention comprises a method and system for allowing a subscriber of equipment used by a calling party, or the calling party, to control, (i) prior to the process of connecting a call, the content of a Ring Back Tone (RBT) played to the calling party based on a maturity level or restriction rating, or (ii) dynamically, during the process of connecting a call. This service could be offered by telecommunication operators to their customers as either a paid, or courtesy feature.

In a first embodiment of the present invention, the Caller's maturity level profile is defined in a database. Such profile can include Boolean information such as whether parental control is implemented or non-Boolean information such as maturity levels or restriction ratings that are correlated to the caller equipment. This information could be kept in a database associated with the originating exchange, such as the Line Information Database (LIDB), or a separate database server such as Home Location Register (HLR) or Home Subscriber Server (HSS). When a call is made by a caller to a called party, the call is routed to a network node, typically a switch or a GMSC of the caller, e.g., the Home GMSC. The Home GMSC queries the HLR of the subscriber that is correlated to the called party equipment to obtain information from a profile of said subscriber. An SCP typically handles the RBT service by invoking the RBT service from, e.g., an Intelligent Peripheral (IP) Player that is adapted to play RBT content to the caller. The mechanism for sending the appropriate RBT content based on caller control to the terminating side can be accomplished using either a push method or a pull method. In case of push method the Caller's maturity level is sent to the RBT service node (either the SCP or the IP Player). Just as there are different protocols that can be used to signal the called party's equipment, there are several methods and systems that can be used to implement the present invention. For example, using a push method, the signaling from the caller may use ISUP to the GMSC and CAMEL from the GMSC to the SCP and CAMEL from the SCP to the IP Player. Alternatively, the signaling may use SIP between these network elements.

In a pull method, the SCP may query the originating exchange or a calling services database or may defer to the IP Player that can query the calling database. In response to information received about the caller, the IP Player may respond, or be directed to respond, with RBT content based on said information. For example, if the information indicates that a caller is under parental control or has a restriction based on a maturity level or restriction rating, RBT content selected by a called party that is not compatible with the restriction can be replaced with more suitable RBT content, and if no suitable content is available, then a default RBT content, such as ringing or equivalent content in other media, can be played to the caller. To implement the pull method, it is a pre-requisite that the RBT content be rated, for example, by a rating organization, and the service provider provides the ability to match the RBT content based on the calling party's maturity level with the content rating.

In a second embodiment of the present invention, a method and system is provided in which a caller, once a call is set in motion (e.g., during call set-up), can disable the playing of RBT content by, for example, entering certain key strokes on the keypad of their equipment, or can skip the then current RBT content selection, prompting the RBT service to select an alternative RBT content.

### BRIEF DESCRIPTION OF THE SEVERAL VIEWS OF THE DRAWING

In the following section, the invention will be described with reference to exemplary embodiments illustrated in the figures, in which:

FIG. 1 is a signaling diagram illustrating the first embodiment of the present invention wherein maturity level or restriction rating information is pushed to an IP Player;

FIG. 2 is a signaling diagram illustrating the first embodiment of the present invention wherein maturity level or restriction rating information is pulled by an IP Player;

FIG. 3 is a flow chart of the steps of a first embodiment of the present invention;

FIG. 4 is a flow chart of the steps of a second embodiment of the present invention; and

FIG. 5 is a block diagram of a system which implements the present invention.

### DETAILED DESCRIPTION OF THE INVENTION

The present invention is adapted to provide a caller with the ability to activate, deactivate and/or otherwise control RBT content as heard on the caller's mobile handset, personal digital assistant, smart-phone, station, terminal, telephone or user equipment (sometimes referred to collectively herein as equipment or telephone). Caller control of RBT includes, but is not limited to the ability to set and/or modify a caller's Boolean or non-Boolean parental control, maturity level or restriction rating setting prior to making a call so as to override a called party's RBT selections and the ability to replace or override a called party's RBT selections while a call is being made by the caller. Other embodiments allow the subscriber whose equipment is correlated to the caller to override or modify the restrictions on a call by call or session by session basis.

The subscriber can further control the call by call or session by session maturity level or restriction rating option according to a predetermined time limit. In other words, the maturity level or restriction rating can be valid until “turned off” by the subscriber, and the subscribed maturity level or restriction rating can remain valid until “turned on” by the sub-scriber. The mechanism is implemented by providing a feature code operable to flip the restriction level by the caller. In one aspect of the present invention, a restriction level is implemented in a non-Boolean manner, such as a progressive level of restriction, hence it is possible for subscriber to move up and down the restriction level. This can be done by making a service call—a call to flip restriction or change the subscription option, e.g., the restriction level. Alternatively, the restriction can be Boolean (either on or off), whereby the subscriber would only have the option to turn a restriction on or off.

In a first embodiment of the present invention, when a call is made by a caller to a called party, the call is routed from an End Office Switch or a Mobile Switching Center (MSC) of the calling party, to a network node, typically an End Office Switch or a Gateway Mobile Switching Center (GMSC) of the called party (the Home GMSC). The calling party's End Office Switch or MSC stores the calling subscriber's profile either permanently, or fetches dynamically from a database such as the home location register (HLR). Such profile can include Boolean information such as whether parental control is implemented or non-Boolean, such as information regarding a maturity level or restriction rating that is correlated to the caller equipment. This information could also be kept in a Home Subscriber Server (HSS). The Home GMSC queries the home location register (HLR) of the subscriber that is correlated to the called party equipment to obtain information from a profile of said subscriber. The mechanism for sending the appropriate RBT content based on caller control to the terminating side can be accomplished using either a push method or a pull method. A Service Control Point (SCP) typically handles the RBT service by invoking the RBT service from, e.g., an Intelligent Peripheral (IP) Player that is adapted to play RBT content back to the caller. Just as there are different protocols that can be used to signal the called party's equipment, there are several methods and systems that can be used to implement the present invention. For example, using the push method, the signaling from the caller may use ISDN User Part (ISUP) to the GMSC and Customized Applications for Mobile Network Enhanced Logic (CAMEL) from the GMSC to the SCP and CAMEL from the SCP to the IP Player. Alternatively, the signaling from the caller may use ISUP to the GMSC and ISUP, Session Initiation Protocol (SIP) or H.232 directly to the IP Player.

In a pull method, the SCP may query the GMSC or a calling services database (which may be the originating switch) or may defer to the IP Player that can query the calling database. In response to information received about the caller, the IP Player may respond, or be directed to respond, with RBT content based on said information. For example, if the information indicates that a caller is under parental control or has a restriction based on maturity level or restriction rating, a RBT content selected by a called party that is not compatible with the restriction can be replaced with more suitable RBT content, and if no suitable content is available, then a default RBT content, such as ringing or equivalent content in other media, can be played to the caller.

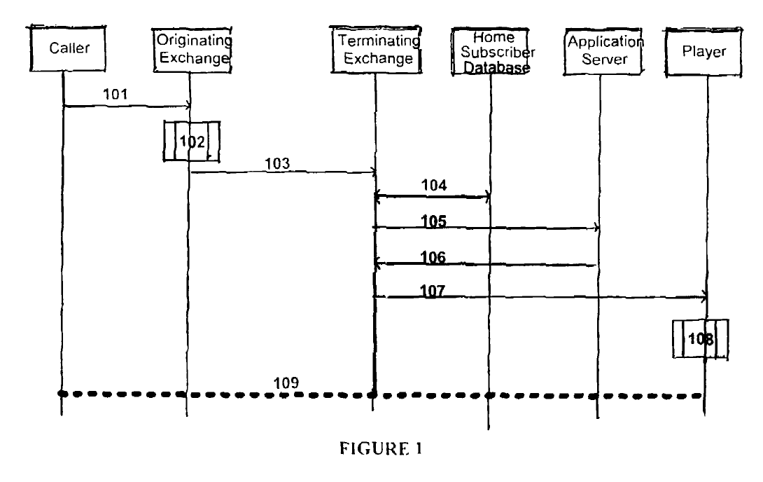

Referring now to FIG. 1, a signaling diagram illustrating the first embodiment of the present invention wherein maturity level or restriction rating information is pushed to an IP Player is provided. As seen therein, in message 101, a caller initiates a call. In message 102, the originating exchange fetches the caller's maturity level or restriction rating from a local or remote database. In message 103, the originating exchange sends the initial message (e.g. ISUP IAM, SIP INVITE, etc.) to the terminating exchange. It includes the caller's maturity level or restriction rating. In message 104, the terminating exchange fetches the called subscriber data from Home Subscriber Database (e.g. HLR, HSS, etc.). In message 105, the terminating exchange contacts the Application Server (e.g. SCP) to take control of the call. In message 106, the Application Server instructs the terminating exchange to connect to the IP Player. In message 107, the terminating exchange connects to the IP Player. It includes the caller's maturity level or restriction rating in the initial message. In message 108, the IP Player selects appropriate tone according to the called subscriber profile and the caller's maturity level or restriction rating. In step 109, the IP Player starts playing RBT content.

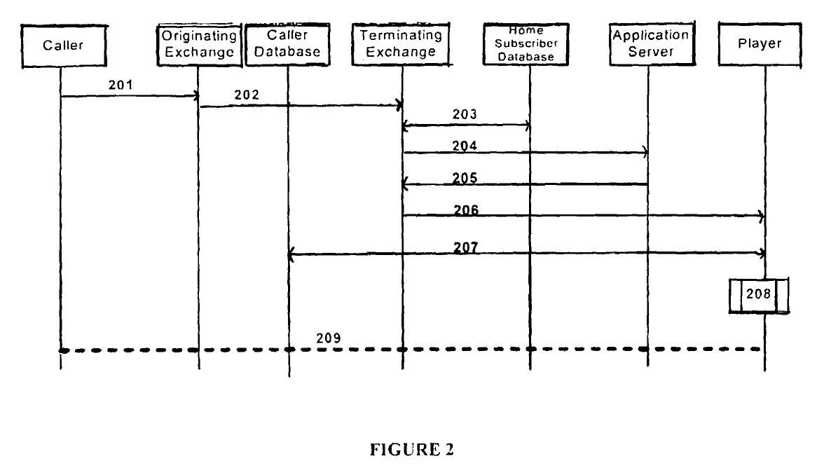

Referring now to FIG. 2, a signaling diagram illustrating the first embodiment of the present invention wherein maturity level or restriction rating information is pulled by an IP Player is provided. As seen therein, in message 201, a caller initiates a call. In message 202, the originating exchange sends the initial message (e.g. ISUP IAM, SIP INVITE, etc.) to the terminating exchange without the caller's maturity level or restriction rating. In message 203, the terminating exchange fetches the called subscriber data from Home Subscriber Database (e.g. HLR, HSS, etc.). In message 104, the terminating exchange contacts the Application Server (e.g. SCP) to take control of the call. In message 205, the Application Server instructs the terminating exchange to connect to the IP Player. In message 206, the terminating exchange connects to the IP Player. In message 207, the Player fetches the caller's maturity level or restriction rating from a database. This database can be a standalone element, or part of a home subscriber database, originating exchange, or some other node. In message 208, the IP Player selects appropriate tone according called subscriber profile and caller's maturity level or restriction rating. In step 209, the IP Player starts playing RBT content.

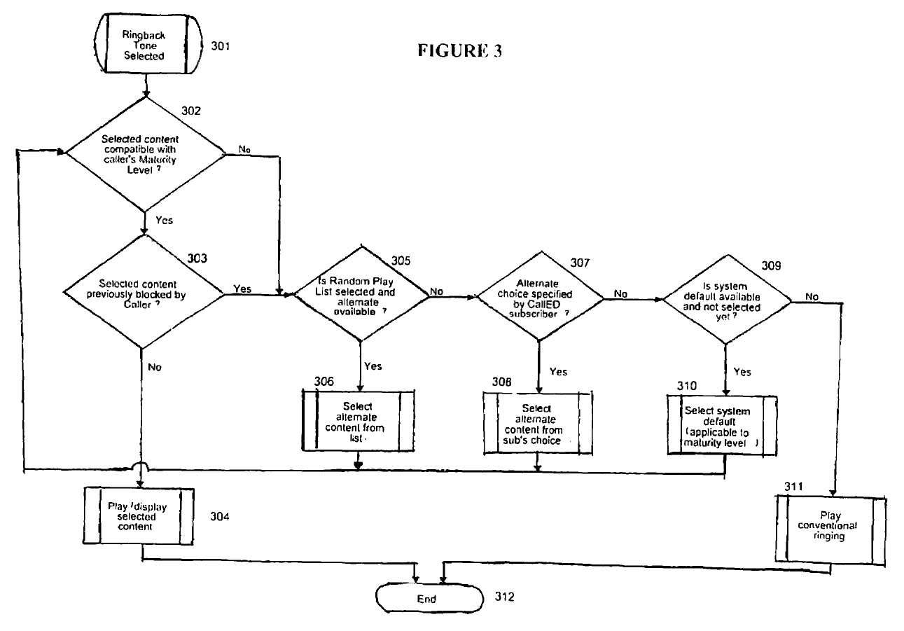

Referring to FIG. 3, a flow chart of the method of a first embodiment of the present invention is provided. For purposes of this embodiment, it is assumed that the subscriber whose equipment is used to call a called party, has a profile stored in a calling party database setting forth a certain maturity level or restriction rating. As seen therein, in step 301, a RBT is selected after the caller has called the called party, based on the called subscriber's RBT profile. In step 302, information in the caller's profile is reviewed against RBT content rating information concerning the called party's RBT content. It is determined, based on this review whether the selected RBT content is compatible with the caller's maturity level or restriction rating. If it is compatible, then in step 303, it is determined if the RBT content was previously blocked by the caller. If it is not blocked, then in step 304, the RBT content is played or displayed to the caller. If, in step 302, the content is not compatible with the caller's maturity level or restriction rating, or if in step 303, the RBT content has previously been blocked, then in step 305, it is determined if a random play list is selected and an alternate RBT content available. If so, then in step 306, an alternate RBT content is selected and the compatibility review/previous block steps 302 and 303 are performed. If not, then in step 307 it is determined whether an alternate RBT content choice selected by the called party is available. If so, in step 308, the alternate RBT content is selected and the compatibility review/previous block steps 302 and 303 are performed. If not, then in step 309, it is determined if a system default is available and not yet selected. If so, then in step 310, the system default is selected and the compatibility review/previous block steps 102 and 103 are performed. If not, then in step 311, a conventional ring is played to the calling party. The method terminates at step 312 after first reaching either step 304 or 311 The first embodiment of the present invention facilitates the provision by service providers to its subscribers the ability to control, for example by blocking, the presentation of inappropriate material to the caller of the equipment, such as adult material and vulgar and offensive songs. In the absence of the present invention, it is not possible for callers to control RBT content, which they may deem offensive.

In the first embodiment of the present invention, information regarding the maturity level or restriction rating of the caller is saved in a calling party database and made available to an SCP or RBT platform. In one aspect of the first embodiment, a caller is automatically assigned a maturity level or restriction rating. Alternatively, the caller, identified by the network based on service agreement or subscription, may voluntarily select or subscribe to a maturity level or restriction rating. This maturity level or restriction rating can be stored locally in the switch, or in a database such as, for example, a Line Information Database, Service Control Point, Home Location Register, or Home Subscriber Server.

When a call, data session, or multimedia session is originated, the originating switch or database is adapted to push the maturity level or restriction rating of the caller to the terminating switch or service provider. In the absence of such forwarding, it is possible for the terminating service provider to pull in the maturity level or restriction rating of the equipment used by the caller from the originating switch on an as-needed basis. The maturity level or restriction rating can then be conveyed from the originating switch to the terminating switch in a number of ways, such as an ISDN User Part (ISUP) Initial Address Message (IAM), CAMEL Application Part/Intelligent Network Application Protocol (CAP/INAP) Initial DP message, and Session Initiation Protocol (SIP): INVITE. In a similar manner, a Transaction Capability Application Part (TCAP) or SIP query from the terminating switch can pull in the maturity level or restriction rating. Both Initial DP and IAM messages support the Calling Party's Category (CPC) parameter, which typically conveys information such as ordinary, test, operator, payphone, prison, hotel, hospital, police, cellular, cellular-roaming, and unknown caller. In the present invention, this parameter is enhanced to include a maturity level or restriction rating as selected by the subscriber/caller and attributed to their equipment. For example, this classification could be child, teen junior, teen senior, young adult, and adult. Instead of extending CPC, it is also possible to use Generic Digits or another parameter to convey the same information to the service platform.

The maturity levels or restriction ratings used by the present invention can be correlated to ratings currently applied to movies and other media. Advantageously, in the present invention, a subscriber is able to assign RBT content appropriate to a caller's maturity level or restriction rating. The present invention can be adapted to specify multiple defaults, one for each content rating and/or maturity level or restriction rating. Similarly, Random Play can also be applied to groups identified only by their maturity level or restriction rating.

This present invention is not limited to facilitating parental control of RBT content. The present invention can be used in any service that is based on the known information regarding the maturity level or restriction rating of the caller, such as gaming applications, video applications, and other applications where legally mandated or user selected restriction on materials presented is required or necessary. The present invention can also be used in connection with the presentation of RBT content (advertisements, or called party selected material) during silent intervals (muted, put on hold, etc.) in a call or communication session.

In a second embodiment of the present invention, a method and system is provided in which a caller, once a call is set in motion, can disable the playing of RBT content by, for example, entering certain key strokes on the keypad of their equipment. For example, when a caller places a call, the caller would have certain options that can be exercised during call placement, or after call placement and during RBT playback:

(1) To deactivate RBT for that particular call, certain entry codes are entered, or prompts responded to, by the caller into an input means of the telephone, such as a keypad, voice recognition system, and/or touchscreen, and are decoded by the system [indicate which parts of the system cooperate to receive and decode and then deactivate or modify the RBT content] (for example, such caller entry may be: “*RBT*P*B-[number]”). Alternatively, this service may be subscribed to on a permanent basis, whereby the subscriber is able to deactivate RBT for all calls. [In such cases, the service may be bound to a telephone by a hardwired circuit, software implemented on the platform or on a Subscriber Identity Module (SIM).]

(2) To deactivate a particular RBT for a particular call, a different entry code can be entered, or prompts responded to, by the caller, such as “*PP”. This can be used in the event that a Random Play RBT option is permitted by the operator. When this code is entered, the Player will jump to the next tone in the list.

(3) To deactivate RBT for a particular call and all future calls, for that particular called party, a different entry code can be entered, or prompts responded to, by the caller, such as “*RBT*C*B-[number]”.

(4) To reactivate RBT for a particular call and all future calls, for that particular called party, a different entry code can be entered, or prompts responded to, by the caller, such as “*RBT*R*B-[number]”. If a caller has permanently subscribed to the deactivation of RBT content, the subscriber may reactivate the RBT on a call by call basis.

(5) To deactivate parental control for a particular call, a different entry code can be entered, or prompts responded to, by the caller, such as “*PC*P*PW*B-[number]” where PW is a password.

(6) To deactivate parental control for that particular call and all future calls, for that particular called party, a different entry code can be entered, or prompts responded to, by the caller, such as “*PC*C*PW*B-[number]”.

(7) To deactivate parental control for that particular call and all future calls, for any called party, a different entry code can be entered, or prompts responded to, by the caller, such as “*PC*A*PW*B-[number]”.

(8) To reactivate parental control for that particular call and all future calls, for that particular called party, a different entry code can be entered, or prompts responded to, by the caller, such as “*PC*R* B-[number], PW.”

All star (*) codes above are defined by the standards or service provider. If the codes are entered during RBT playback then “*B-[number]” at the end are not required.

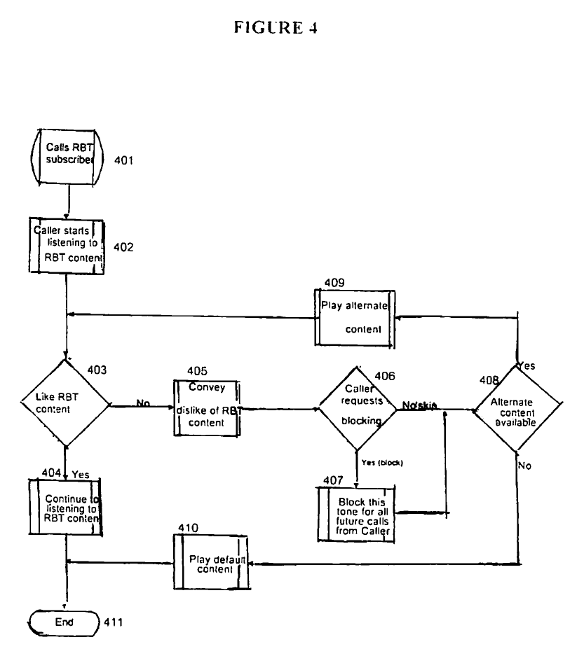

FIG. 4 is a flow chart of the steps of a second embodiment of the present invention. As seen therein, in step 401, a calling party calls a called party who is an RBT subscriber. In step 402, a caller starts listening to or viewing the RBT content of the called party. In step 403, the caller decides if they like the RBT content. If they like the RBT content, then in step 404, they continue to listen to or view it until the called party answers and the process ends at step 411. If they do not like the RBT content at step 405, then at step 406, the caller can have the option to request blocking of that particular RBT content. At step 407, the caller can block the particular RBT content for all future calls made from the caller's equipment. If the caller does not want to block future RBT content, they can, nevertheless, in step 408, request if alternate RBT content is available. If alternate RBT content is available, it can be played and/or displayed at step 409. With respect to this alternate RBT content, the method returns to step 403 so that the caller can determine if they like the alternate RBT content with the method continuing to steps 404 or 405 depending on that determination. If no alternate content is available, then in step 41 0, default RBT content is played and/or displayed until the called party answers and the process ends at step 411.

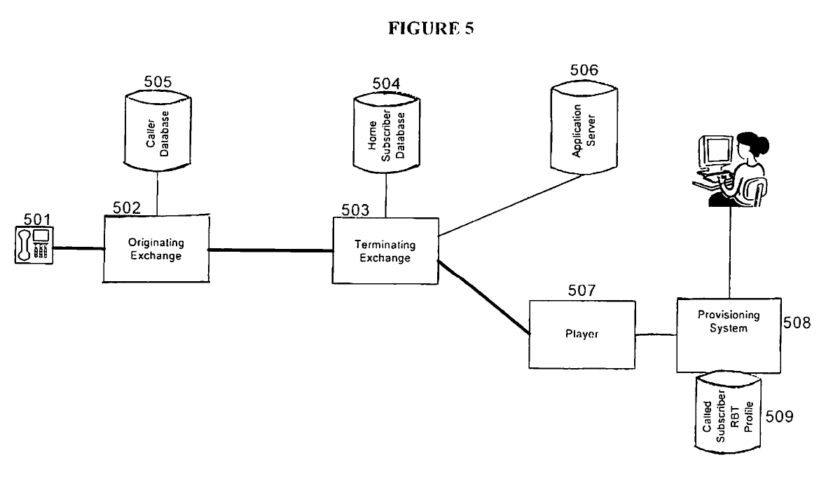

Referring now to FIG. 5, a block diagram of a system adapted to perform the steps of the invention is illustrated. Seen therein are calling party equipment 501 which is coupled to an originating switch 502. Originating switch 502 is then coupled to called party GMSC 503, which is coupled to called party HLR 504. Called party HLR 504 is coupled to calling party database 505. Calling party database 505 retains a profile of the level or restriction rating attributed to the equipment of the calling party. SCP 506 and IP Player 507 are also coupled to called party GMSC 503. Called party provisioning system 508 is coupled to IP Player 507 and called party RBT profile 509 is coupled to provisioning system 508.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

What is claimed:

1. A method for connecting a calling party to a called party in a telecommunications system, comprising the step of controlling Ring Back Tone (RBT) content played or displayed to a calling party.

2. The method of claim 1, wherein the step of controlling RBT content is based on a provisioned or subscribed restriction (maturity level).

3. The method of claim 1, wherein the calling party controls the RBT content dynamically during call setup time.

4. The method of claim 3, wherein dynamic control is permitted only if not restricted by subscription, and if permitted, RBT content is overridden based on the use of a personal identification number or based on time.

5. The method of claim 1, wherein the step of controlling, by the subscriber of equipment used by the calling party, the RBT content is based on a maturity level or restriction rating.

6. The method of claim 5, further comprising the step of modifying a maturity level or restriction rating by the subscriber of equipment used by the calling party.

7. The method of claim 5, wherein the RBT content that is selected to be played or displayed to the calling party is appropriate to the maturity level or restriction rating of the equipment used by the calling party.

8. The method of claim 1, further comprising the step of overriding the called party's RBT content selection based on a calling party profile.

9. The method of claim 1, further comprising the step of deactivating all RBT content if a predetermined maturity level or restriction rating attributed to the equipment used by the calling party is met.

10. The method of claim 1, further comprising the steps of:
prior to connecting equipment of the calling party to equipment of the called party, correlating, by a subscriber of said equipment used by the calling party, to different maturity levels or restriction ratings;
during the process of connecting the equipment of the calling party to the equipment of the called party, referring to the maturity level or restriction rating correlated to the equipment of the calling party; and
presenting RBT content from an RBT platform appropriate to the maturity level or restriction rating correlated to the equipment used by the calling party.

11. The method of claim 10, wherein the maturity levels or restriction ratings correlated to the equipment of the calling party are maintained by a service provider.

12. The method of claim 10, wherein the maturity level or restriction rating settings correlated to the equipment of the calling party are maintained at one of an originating switch of the calling party or in a memory location of a handset.

13. The method of claim 1, wherein the equipment comprises one selected from the group consisting of: a mobile handset, personal digital assistant, smart-phone, station, terminal, telephone and user equipment.

14. The method of claim 1, further comprising transmitting information by the calling party to a network node during the process of call set up that is adapted to deactivate or modify RBT content played to the calling party.

15. The method of claim 14, further comprising the step of selecting, deactivating or modifying RBT content on a call by call or session by session basis.

16. A method of alerting a calling party that a connection to a called party in a telecommunications system is being attempted, comprising the steps of:
transmitting information regarding a maturity level or restriction rating correlated to an equipment used by the calling party to an RBT platform from a network node; and
causing the selection of RBT content to be conveyed to the equipment used by the calling party based on the maturity level or restriction rating.

17. The method of claim 16, wherein the network node is one from the group consisting of an end office switch and a Mobile Switching Center (MSC).

18. The method of claim 16, further comprising the step of causing the conveyance, by the RBT platform, of a standard ring tone or default RBT content to the equipment of the calling party if no appropriate content is specified as a substitute.

19. The method of claim 16, further comprising the step of overriding a subscribed class of restriction according to a predetermined time limit.

20. A method of notifying a calling party that a call to a called party in a telecommunications system is being connected, comprising the steps of:
querying a database of a service platform as to a class of maturity level or restriction rating applicable to an equipment used by the calling party; and
causing the selection of RBT content to be conveyed to the equipment used by the calling party based on the class of maturity level or restriction rating.

21. A system for connecting a calling party to a called party in a telecommunications system, comprising a means of controlling or overriding the content of a Ring Back Tone (RBT) played to the calling party on an equipment of the calling party.

22. The system of claim 21, wherein said system comprises a network node adapted to store maturity levels and restriction ratings data correlated to the equipment used by the calling party, said network node adapted to convey said data to an RBT platform used to store RBT content correlated to the equipment of a called party; and
wherein the RBT content played or displayed to a calling party is based on a matching of maturity levels or restriction ratings attributed to the RBT content and the equipment used by the calling party.

23. The system of claim 22, wherein the network node comprises one from the group consisting of an end office switch and a Mobile Switching Center (MSC).

24. The system of claim 22, wherein a called party selects RBT content to be correlated to the maturity levels or restriction ratings of the equipment used by the calling party.

25. The system of claim 22, wherein a service provider provides default RBT content that is presented to the equipment used by the calling party based on the maturity level or restriction rating.

26. The system of claim 22, wherein the RBT platform is adapted to substitute RBT content, based on the maturity level or restriction rating of the equipment used by calling party.

27. The system of claim 22, wherein the RBT platform is adapted to cause the conveyance of a standard ring tone or default RBT content to the equipment of the calling party or subscriber if no appropriate content is specified or available as a substitute.

28. The system of claim 22, further comprising a service platform adapted to query a database which maintains a maturity level or restriction rating correlated to the equipment of the calling party or subscriber.

29. The system of claim 22, having calling party equipment coupled to an originating switch, the originating switch coupled to calling party Gateway Mobile Switching Center (GMSC), the calling party GMSC coupled to a calling party Home Location Register (HLR), a Service Control Point (SCP) and Intelligent Peripheral (IP) Player being coupled to calling party GMSC, a called party provisioning system being coupled to the IP Player and a called party Ring Back Tone (RBT) platform being coupled to the provisioning system, the system further comprising:
a calling party database coupled to the calling party HLR, said calling party database adapted to retain a profile of the maturity level or restriction rating attributed to equipment of the calling party.

30. The system of claim 29, wherein the calling party database is adapted to store maturity levels and restriction ratings data correlated to the equipment used by the calling party, said calling party database adapted to convey said data to the RBT platform used to store RBT content correlated to the equipment of a called party; and
wherein the IP Player is directed to play or display RBT content to a calling party based on a matching of maturity levels or restriction ratings attributed to the RBT content and the equipment used by the calling party.

31. The system of claim 22, further comprising a means adapted to permit a calling party to cause a network node to override RBT content on a call by call or session by session basis as directed by the calling party.

32. The system of claim 31, further comprising a mechanism within a service platform adapted to override a subscribed class of restriction according to a predetermined time limit.

33. The system of claim 31, wherein the means is implemented by providing a feature code operable to change a subscribed maturity level or restriction rating.

34. The system of claim 33, wherein the network node progressively implements a maturity level or restriction rating and is adapted to permit the calling party to move up and down the maturity level or restriction rating.

35. The system of claim 33, wherein the maturity level or restriction rating is Boolean, adapted to permit the calling party or subscriber to activate or deactivate a maturity level or restriction rating.

36. The system of claim 22, further comprising a means in equipment used by the caller to control RBT content.

37. The system of claim 36, further comprising an input means to the equipment adapted to permit a calling party to select options relating to the play or display of RBT content.

38. The system of claim 37, wherein said input means is one selected from the group consisting of a keypad, voice recognition system, and touchscreen.

39. The system of claim 38, further comprising software executable on hardware that can be programmed to permit an action selected from the group consisting of: deactivate RBT for a particular call; deactivate RBT for all calls; deactivate RBT on a call by call basis; deactivate a particular RBT for a particular call; deactivate a particular RBT for all calls; deactivate RBT for a particular call and all future calls for a particular called party; reactivate RBT for all calls; reactivate RBT on a call by call basis; reactivate a particular RBT for a particular call; reactivate a particular RBT for all calls; reactivate RBT for a particular call and all future calls for a particular called party; deactivate parental control for a particular call; deactivate parental control for a particular call and all future calls; deactivate parental control for a particular call and all future calls for a particular called party, deactivate parental control for a particular call and all future calls for any called party; reactivate parental control for a particular call; reactivate parental control for a particular call and all future calls; reactivate parental control for a particular call and all future calls for a particular called party; and reactivate parental control for a particular call and all future calls for any called party.

40. A subsystem for connecting equipment of a calling party to equipment of a called party in a telecommunications system, comprising:
a means for querying a calling party database of a service platform as to a class of maturity level or restriction rating applicable to an equipment of a calling party; and
a means for causing the selection of RBT content to be conveyed to the equipment of the calling party based on the class of maturity level or restriction rating.

41. A platform used in connecting a calling party or subscriber to a called party in a telecommunications system, comprising a first node having hardware and software for storing profiles of the calling party related to maturity levels or restriction ratings, said node in communication with a second node that is adapted to control the content of a Ring Back Tone (RBT) played on equipment of the calling party based on the maturity levels or restriction ratings.

42. The platform of claim 41, wherein the first node comprises a switch or database selected from the group consisting of a Line Information Database, Service Control Point, Home Location Register, and Home Subscriber Server.

43. The platform of claim 41, adapted to present RBT content as determined by a network service provider.

44. The platform of claim 41, adapted to present RBT content having a certain maturity level or restriction rating as determined by a subscriber to the equipment used by calling party pursuant to a service agreement or subscription.

45. The platform of claim 44, wherein the maturity level or restriction rating is stored locally in the first node, said first node further comprising an originating switch or a database server.

46. The platform of claim 45, wherein the first node is an originating switch that is adapted, when a call, data session, or multimedia session is originated, to forward the maturity level or restriction rating of the calling party or subscriber to the second node which is a terminating switch.

47. The platform of claim 46, wherein the maturity level or restriction rating is conveyed from the originating switch to the terminating switch using one from the group consisting of an ISDN User Part (ISUP) Initial Address Message (IAM), CAMEL Application Part/Intelligent Network Application Protocol (CAP/INAP) Initial DP message, and Session Initiation Protocol (SIP): INVITE.

48. The platform of claim 46, wherein the terminating switch is adapted to pull in the maturity level or restriction rating of the equipment used by the calling party from the originating switch on an as-needed basis.

49. The platform of claim 48, wherein the terminating switch is adapted to pull in the maturity level or restriction rating of the equipment used by the calling party from the originating switch using one from the group consisting of: a Transaction Capability Application Part (TCAP) and a SIP query.
